(19) United States
(12) Patent Application Publication
(10) Pub. No.: US 2017/0186021 A1
(43) Pub. Date: Jun. 29, 2017

(54) METHOD AND SYSTEM FOR IDENTIFYING HIGH GROWTH E-COMMERCE BUSINESSES

(71) Applicant: MasterCard International Incorporated, Purchase, NY (US)

(72) Inventors: Edward Lee, Scarsdale, NY (US); Pavel Umanski, Brooklyn, NY (US); Nadine Davey-Rogers, Miami Shores, FL (US); Serge Bernard, Danbury, CT (US); Henry Weinberger, New York, NY (US)

(73) Assignee: MasterCard International Incorporated, Purchase, NY (US)

(21) Appl. No.: 14/982,675

(22) Filed: Dec. 29, 2015

(51) Int. Cl. G06Q 30/02; G06Q 50/00; G06Q 40/00

(52) U.S. Cl. CPC G06Q 30/0201; G06Q 40/12; G06Q 50/01

(57) ABSTRACT

A method for identifying a high growth business from combined data sets comprising: storing, a plurality of data elements configured to store at least a merchant identifier, acceptance flag, transaction date, and transaction amount; receiving, a merchant growth request command including at least a specific merchant identifier associated with a specific merchant; executing, a query on the transaction database to identify a subset of transaction messages; determining, a transaction volume over time for the specific merchant based on at least the transaction amount and transaction date; identifying, social media data associated with the specific merchant, and a growth index for the specific merchant based on at least the transaction volume over time determined for the specific merchant and the measure of social media presence over time based on the associated dates.

### FIELD

The present disclosure relates to the identifying high growth e-commerce businesses, specifically the generation of indices based on business growth using transaction data and social media data and use of the indices to high growth e-commerce businesses.

### BACKGROUND

Currently, success in a small business is often defined by its ability to grow online and brick and mortar sales. However, it can difficult to determine and identify high potential growth small businesses in general or within specific industries.

Data associated with transactions and social media is often desired by a number of entities for a number of uses. Investors, merchants, retailers, content providers, and other such entities often use such data to determine what products to purchase and/or sell, what merchants are growing, and where to market the products. A particular set of metrics that many entities may be interested in are metrics associated with a high growth e-commerce businesses.

However, information captured from even the transaction data alone can be difficult for many entities to review and analyze, particularly due to the millions of electronic payment transactions that are processed each day. In addition, the vast amount of detail included in electronic payment transactions and social media data may also be difficult for entities to analyze and sort through to identify desired information.

Thus, there is a need for a technical solution to provide detailed analysis of a vast amount of electronic payment transaction data and social media data that can distill the data into an index that is readily usable and understandable by a plurality of entities. The generation and use of an index associated with the transaction data and social media data may provide for simplified analysis when used by entities that are unable to possess sensitive transactional information and perform the complex calculations and determinations required to analyze such data.

### SUMMARY

The present disclosure provides a description of systems and methods for identifying high growth e-commerce businesses.

A method for identifying a high growth business from combined data sets, comprises: storing, in a transaction database of a processing server, a plurality of transaction messages, wherein each transaction message is formatted based on one or more standards and includes data related to a payment transaction including a plurality of data elements configured to store at least a merchant identifier, acceptance flag, transaction date, and transaction amount; receiving, by a receiving device of the processing server, a data signal superimposed with a merchant growth request command, wherein the merchant growth request command includes at least a specific merchant identifier associated with a specific merchant; executing, by a querying module of the processing server, in response to the merchant growth request command a query on the transaction database to identify a subset of transaction messages where the included merchant identifier corresponds to the specific merchant identifier; determining, by an evaluation module of the processing server, a transaction volume over time for the specific merchant based on at least the transaction amount and transaction date stored in the plurality of data elements included in each transaction message in the identified subset; identifying, by an identification module of the processing server, social media data associated with the specific merchant, wherein the social media data includes a plurality of social data values, each social data value being associated with a date and a measure of social media presence; identifying, by an indexing module of the processing server, a growth index for the specific merchant based on at least the transaction volume over time determined for the specific merchant and the measure of social media presence over time based on the associated dates; and electronically transmitting, by a transmitting device of the processing server, a data signal in response to the received data signal, wherein the transmitted data signal is superimposed with at least the identified growth index.

A system for identifying a high growth business from combined data sets, comprises: a transaction database of a processing server configured to store a plurality of transaction messages, wherein each transaction message is formatted based on one or more standards and includes data related to a payment transaction including a plurality of data elements configured to store at least a merchant identifier, acceptance flag, transaction date, and transaction amount; a receiving device of the processing server configured to receive a data signal superimposed with a merchant growth request command, wherein the merchant growth request command includes at least a specific merchant identifier associated with a specific merchant; a querying module of the processing server configured to execute, in response to the merchant growth request command a query on the transaction database to identify a subset of transaction messages where the included merchant identifier corresponds to the specific merchant identifier; an evaluation module of the processing server configured to determine a transaction volume over time for the specific merchant based on at least the transaction amount and transaction date stored in the plurality of data elements included in each transaction message in the identified subset; an identification module of the processing server configured to identify social media data associated with the specific merchant, wherein the social media data includes a plurality of social data values, each social data value being associated with a date and a measure of social media presence; an indexing module of the processing server configured to identify a growth index for the specific merchant based on at least the transaction volume over time determined for the specific merchant and the measure of social media presence over time based on the associated dates; and a transmitting device of the processing server configured to electronically transmit a data signal in response to the received data signal, wherein the transmitted data signal is superimposed with at least the identified growth index.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for identifying high growth e-commerce businesses in accordance with exemplary embodiments.

FIG. 2 is a block diagram illustrating the processing server of FIG. 1 for identifying high growth e-commerce businesses in accordance with exemplary embodiments.

FIG. 3 is a flow diagram illustrating a process for the generation of an index and use thereof in identifying high growth e-commerce businesses in accordance with exemplary embodiments.

FIG. 4 is a diagram illustrating the indexing of identifying high growth e-commerce businesses in accordance with exemplary embodiments.

FIG. 5 is a flow chart illustrating an exemplary method for generating a model for indexing neighborhood growth in accordance with exemplary embodiments.

FIG. 6 is a flow diagram illustrating the processing of a payment transaction in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPall®, etc. Use of the term “payment network” herein may refer to both the payment network as an entity, and the physical payment network, such as the equipment, hardware, and software comprising the payment network.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have and require special knowledge in offered products. In some embodiments, an entity involved in a single transaction may be considered a merchant. In some instances, as used herein, the term “merchant” may refer to an apparatus or device of a merchant entity.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

Social Network—A social network may be an entity that operates a network which hosts social websites. The social network may also operate the hardware and/or software used in the management and operation of the network, such as the websites and application programs used by the individual and their followers in accessing the network. Social networks may include, for example, Facebook®, Twitter®, FourSquare®, Snapchat®, Google+®, YouTube®, etc. The social network may provide for a network of social interactions and relationships that is used by individuals to manage the relationships and interactions and share content with their followers in the social network, such as by sharing images, audio, video, text, etc.

Data Provider—he data provider may be an entity which is configured to collect social network data from the social network. The social network data may include data related to content shared by users of the social network, as well as information associated with individual users and their followers. In an exemplary embodiment, the social network data collected by the data provider may be data that the individual has given permission for the collection thereof (e.g., by “opting-in” to the collection of the social network data). In some instances, the data collected regarding the individual's followers may only be collected for those followers that have also opted-in for data collection. The data provider may be configured to electronically transmit data signals to the processing server that are superimposed with the social network data using a suitable communication network, such as the Internet, a local area network, a wireless area network, a radio frequency network, etc. In some instances, the data provider may electronically transmit data signals associated with each user of the social network. In other instances, the data provider may aggregate user social network data in data signals that are electronically transmitted to the processing server, such as to reduce the number of transmissions.

### System for Identifying High Growth E-Commerce Businesses

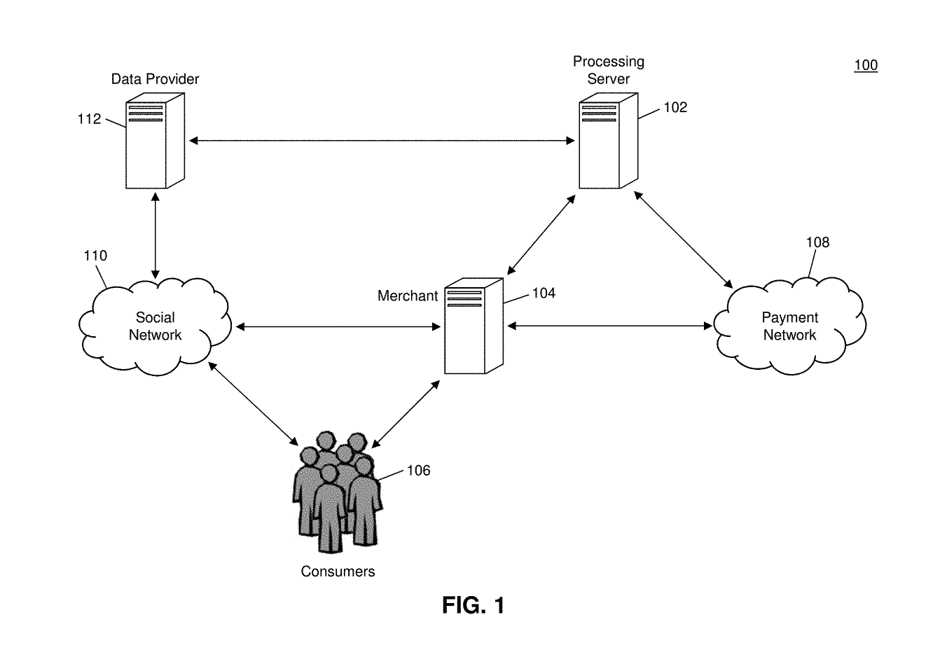

FIG. 1 is a block diagram illustrating a high level system 100 architecture for identifying high growth e-commerce businesses in accordance with exemplary embodiments.

The system 100 may include a processing server 102. The processing server 102, discussed in more detail below, may be configured to generate a model for indexing data based on at least a transaction volume and a measure of social media presence and apply the model to transaction data to identify high growth e-commerce businesses. The processing server 102 may be configured to identify transaction data associated with each of a plurality of consumers 106, and merchants 104, illustrated in FIG. 1.

The transaction messages received by the processing server 102 may include at least a first data element configured to store a payment transaction including a plurality of data elements configured to store at least a merchant identifier, acceptance flag, transaction data, and transaction amount. The transaction messages may be stored in a transaction database.

The merchant identifier may be one or more of a merchant identification number, a transaction account number, a registration number, a point of sale device identifier and/or any other identifier. The acceptance flag may be indicative of: a card not present transaction, a card present transaction when the requested growth index is for physical growth, a card not present when the requested growth index is for e-commerce growth. The transaction data may include, for example, transaction time, transaction date, geographic location, primary account number, consumer data, merchant data, issuer data, acquirer data, point of sale data, loyalty data, reward data, offer data, and/or product data, etc. In some embodiments, the transaction message may also include a message type indicator indicative of an authorization request. The transaction amount may include, for example, the amount charged during the transaction and/or the discount received during the transaction.

Each transaction message may also include additional transaction data associated with the related payment transaction, such as a transaction amount, transaction time, transaction date, merchant data (e.g., merchant name, merchant identification number, merchant category code, merchant industry, etc.), product data, consumer data, offer data, reward data, loyalty data, etc.

The processing server 102 may be configured to receive a data signal superimposed with a merchant growth request command, wherein the merchant growth request command includes at least a specific merchant identifier associated with a specific merchant. The merchant growth request may include an indication of a request for a growth index related to one of: physical (e.g., card present) growth and e-commerce growth. Each transaction message in the identified subset includes a card present acceptance flag indicative of a card present transaction if the requested growth index is for physical growth or includes a card not-present acceptance flag indicative of a card not present transaction if the requested growth index is for e-commerce growth.

The processing server 102 may be configured to execute, in response to the merchant growth request command a query on the transaction database to identify a subset of transaction messages where the included merchant identifier corresponds to the specific merchant identifier.

The processing server 102 may be configured to determine a transaction volume over time for the specific merchant based on at least the transaction amount and transaction date stored in the plurality of data elements included in each transaction message in the identified subset. Each transaction message in the identified subset includes an acceptance flag indicative of a card not present transaction.

The processing server 102 may be configured to identify social media data associated with the specific merchant, wherein the social media data includes a plurality of social data values, each social data value being associated with a date and a measure of social media presence. Identifying social media data associated with the specific merchant may comprise receiving a data signal superimposed with the social media data.

Identifying social media data associated with the specific merchant may comprise receiving a data signal superimposed with a plurality of social media mentions data. Social media mention data may include at least a date/time and associated content. Where a merchant is mentioned, and optionally an indication of whether the merchant is mentioned foreseeably or not. Identifying if the mention is favorable be done manually, but given the volume of potentially thousands of mentions, may be automated by, for instance, detecting the presence of key words (e.g., “good”, “excellent”, “poor”, etc.) or ratings such as stars on Yelp® etc. These may be converted to social data values (e.g., positive or negative, on a scale (e.g., number of stars, etc.)). The social data values may then be converted for a measurement of social media presence associated with a merchant or type of merchant. This can be a simple calculation, e.g., counting positive and/or negative mentions as a measure, but more complicated calculations may also be implemented.

The processing server 102 may identify the plurality of social data values. The associated measure of social media presence may be based on the content associated with each social media mention that includes a date corresponding to the respective associated date. The content associated with each social media mention may be related to the specific merchant or type of merchant and/or other category.

The processing server 102 may be configured to identify a growth index for the specific merchant based on at least the transaction volume over time determined for the specific merchant and the measure of social media presence over time based on the associated dates.

The processing server 102 may be configured to electronically transmit a data signal in response to the received data signal, wherein the transmitted data signal is superimposed with at least the identified growth index.

The processing server 102 may be configured to store a plurality of social media data entries. Each social media data entry may include a structured data set related to a social media mention including at least a date and associated content. Identifying social media data associated with the specific merchant includes identifying, the plurality of social data values, wherein the associated measure of social media presence is based on the content associated with each social media mention that includes a date corresponding to the respective associated date. The content associated with each social media mention is related to the specific merchant.

The processing server 102 may be configured to store a plurality of merchant profiles, wherein each merchant profile includes a structured data set related to a merchant including at least a merchant identifier and merchant information.

The processing server 102 may be configured to a query on the merchant database to identify a specific merchant profile where the included merchant identifier corresponds to the specific merchant identifier. The transmitted data signal is further superimposed with the merchant information included in the identified specific merchant profile. The merchant information may include at least one of: name, geographic location, description, financial data, industry, and category code.

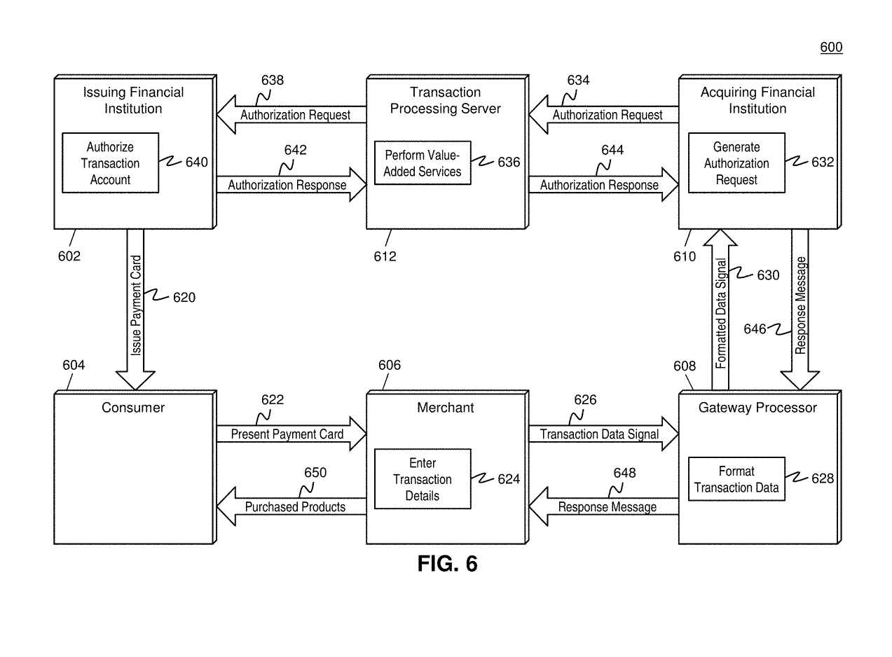

The merchants 104 may participate in payment transactions for the purchase of goods and/or services by consumers. Payment transactions may be processed by one or more payment networks 108. As part of the processing, the merchants 104 may submit transaction data for payment transactions to the payment network 108 via the payment rails described with reference to FIG. 6. In some instances, the transaction data may be forwarded via one or more intermediate entities, such as a gateway processor or acquiring financial institution. The merchants 104 may submit transaction data in one or more data signals, which may be reformatted by an intermediate entity into a transaction message that is submitted to the payment network 108.

Transaction messages may be data messages that are specially formatted pursuant to one or more standards governing the exchange of financial transaction messages, such as the International Organization for Standardization's ISO 8583 standard. Each transaction message may include a plurality of data elements configured to store data as set forth in the associated standard(s) and may also include a message type indicator indicative of a type of transaction message, a bitmap that indicates the number and content of data elements included therein, and additional data. Further information regarding transaction messages and payment rails is discussed in more detail below in respect to the process 600 illustrated in FIG. 6.

The payment network 108 may be configured to forward transaction messages for payment transactions involving the merchants 104 to the processing server 102. In some embodiments, the transaction messages may be forwarded via the payment rails. In other embodiments, the transaction messages may be electronically transmitted via one or more suitable alternative communication networks. In some instances, the processing server 102 may be a part of the payment network 108. In such an instance, the processing server 102 may receive the transaction messages via internal communication of the computing systems of the payment network 108. In some such instances, the processing server 102 may be further configured to perform processing functions of payment transactions for the payment network 108, and may obtain the transaction messages via the associated functions (e.g., by receipt from an acquiring financial institution for processing).

The consumers 106 may be individuals who purchase goods and services from merchants 104 for personal use. The consumers 106 may interact on the social network 110 with other consumers and share information.

The social network 110 may be an entity that operates a network which hosts social websites. Social networks may include, for example, Facebook, Twitter, FourSquare, Snapchat, Google+, YouTube, etc. The social network may provide for a network of social interactions and relationships that is used by the consumers to manage the relationships and interactions and share content with their followers in the social network, such as by sharing images, audio, video, text, etc. The consumers may have followers which may be other users of the social network 110 that “follow” or “like” the consumer 106 and/or merchant 104, and are therefore recipients of content shared by the consumer 106. When content, such as a message, image, or video, is shared by the consumer 106, each of the followers may receive or otherwise be able to view the shared content. Each of the followers may also have followers of their own that view content shared by themselves, which may include individually produced content, or may be a re-sharing of the content shared by the consumer 106.

Data providers 112 may include, for example, research firms, data collection agencies, governmental agencies, and other entities that may gather and/or possess demographic data within geographic boundaries (e.g., zip code, city, state, country). The demographic data may be electronically transmitted to the processing server 102 using a suitable communication network, such as the Internet, a local area network, cellular communication network, radio frequency network, etc. The demographic data may also include, including property data (e.g., property size, property type, etc.), merchant data (e.g., number of merchants, merchant revenue, merchant type, merchant size, etc.), consumer data (e.g., number of consumers, age, gender, income, occupation, education, residential status, familial status, marital status, etc.), etc.

The processing server 102 may be configured to generate a model for identifying high growth e-commerce businesses. The model may be generated based on at least the purchase behaviors of a plurality of consumers 106 at different merchants 104, and identifying social media buzz on a social network 110. The indexing model may be based on the correspondence between social media presence over time and transaction volume, to identify associations therewith.

For example, the transaction volume data may be a period of months (e.g., 12-24) where credit card transaction data (e.g., with e-commerce and/or brick and mortar flag) are analyzed. Data affiliated with the merchant 104 may be aggregated for the period of months. Social media data may be additionally monitored during the period of time to determine “buzz” of the merchant. These may be converted into a measurement of social media presence.

The measure of social media presence (e.g., “buzz”) may correspond to one or more merchants 104 interested in by a majority of consumers 106. Monitoring the social media presence may correspond to keeping track of consumer responses to commercial services and products of the particular merchants 104 to establish the marketing buzz surrounding a new or existing offer. Monitoring the buzz affiliated with each merchant 104 may involve the checking and analysis of myriad online social networks. In some implementations, other online sources such as internet forums, blogs, and/or websites may additionally be monitored to determine buzz. Buzz data can be provided in real time and may be helpful to improve efficiency, reaction times and identify future opportunities. Insights gained can help guide marketing and communications, identify positive and negative customer experiences, assess product and service demand, tackle crisis management, round off competitor analysis, establish brand equity and predict market share.

An algorithm to match the business's social media buzz and the corresponding transaction volume for a period of time may provide predictive analysis to determine high growth potential in businesses. Models may be generated by the processing server 102 to show projected growth of a business based on the collected data. Mathematical modeling of information is described in, for example, “Developing High Quality Data Models,” by Matthew West and Julian Fowler, published by the European Process Industries STEP Technical Liaison Executive (EPISTLE) in 1999, which is herein incorporated by reference in its entirety. This analysis of the data may provide a ranked list of businesses by industry and/or geographical location of businesses identified as having a high ecommerce growth potential.

The systems and methods discussed herein enable the processing server 102 to efficiently and accurately generate a model for identifying high growth businesses. By utilizing transaction messages related to payment transactions, the purchase behaviors identified by the processing server 102 may be more accurate than transaction data obtained directly from merchants 104, and may also be more complete as it may include a majority of merchants 104 in a geographic area as well as merchants 104 in multiple geographic areas. Transaction data and social media data may be difficult and/or impossible to obtain and store in traditional computing systems. In addition, traditional computing systems may be unable to efficiently analyze such volumes of transactions, which may number in the millions or billions for some geographic areas and/or groups thereof. As a result, the data generated by the processing server 102 may be an efficiently and effective measure of high ecommerce growth potential businesses.

### Processing Server

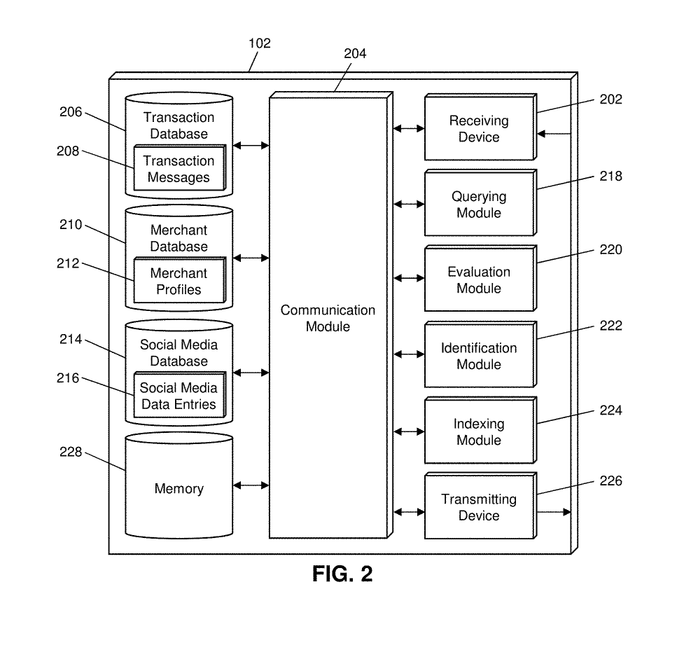

FIG. 2 is a block diagram illustrating the processing server of the system 100 in FIG. 1 for identifying high growth e-commerce businesses in accordance with exemplary embodiments.

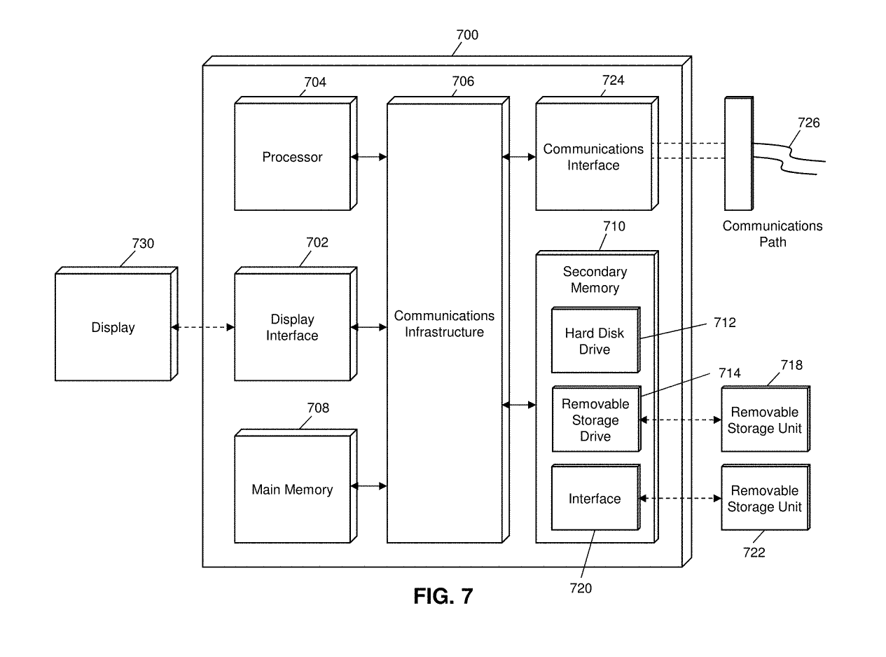

It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 700 illustrated in FIG. 7 and discussed in more detail below may be a suitable configuration of the processing server 102.

The receiving device 202 of the processing server 102 may be configured to receive a data signal superimposed with a merchant growth request command. The merchant growth request command may include at least a specific merchant identifier associated with a specific merchant or type of merchant.

In some implementations, the receiving device 202 may be configured to receive data over one or more networks via one or more network protocols. In some embodiments, the receiving device 202 may be configured to receive data over the payment rails, such as using specially configured infrastructure associated with payment networks 108 for the transmission of transaction messages that include sensitive financial data and information. In some instances, the receiving device 202 may also be configured to receive data from merchants 104, payment networks 108, social networks 110, data providers 112, and/or other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically data signals that are transmitted, where data may be superimposed on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing server 102 to carry out the methods and systems described herein.

The receiving device 202 may be configured to receive data signals from payment networks 108, which may be electronically transmitted via the payment rails or other suitable communication network, and may be superimposed with or otherwise comprise transaction messages for payment transactions. The receiving device 202 may also receive data signals from data providers 112. In some instances, data signals received from data providers 112 may also be superimposed with social activity data associated with geographic areas.

The processing server 102 may include a communication module 204. The communication module 204 may be configured to transmit data between modules, engines, databases, memories, and other components of the processing server 102 for use in performing the functions discussed herein. The communication module 204 may be comprised of one or more communication types and utilizes various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc.

In some embodiments, the processing server 102, as shown in FIG. 1, may include and/or be comprised of a plurality of engines and/or modules specially configured to perform one or more functions, such as a receiving device 202, a querying module 218, an evaluation module 220, an identification module 222, an indexing module 224, a transmitting device 226, a transaction database 206, a merchant database 210, a social media database 214 and/or a memory 228. As used herein, the term “module” may be hardware particularly programmed to receive an input, perform one or more processes using the input, and provide an output. The input, output, and processes performed by various modules will be apparent to one skilled in the art based upon the present disclosure.

The processing server 102 may include a transaction database 206 of a processing server configured to store a plurality of transaction messages 208. Each transaction message may be formatted based on one or more standards and include data related to a payment transaction including a plurality of data elements configured to store at least a merchant identifier, acceptance flag, transaction date, and transaction amount.

In some implementations, the transaction database 206 may store a plurality of transactions messages 208 received from the merchant, the payment network, the social network, the consumers, and/or the data provider. The transactions messages 208 may be linked to a consumer identifier, consumer profile, merchant identifier, merchant profile, social network identifier, social network profile and/or any other identifier. Each stored transaction message may be linked to a date of the transaction, amount of the transaction, and/or whether an acceptance flag was triggered.

The merchant identifier may be one or more of a merchant identification number, a transaction account number, a registration number, a point of sale device identifier and/or any other identifier.

The acceptance flag may be indicative of: a card not present transaction, a card present transaction when the requested growth index is for card present growth (e.g., brick and mortar sales) and/or a card not present when the requested growth index is for e-commerce growth.

The transaction data may include, for example, transaction time, transaction date, geographic location, primary account number, consumer data, merchant (e.g., identification, location, merchant type, or MCC code, etc.), issuer (e.g., identification, etc.), acquirer (e.g., identification, etc.), point of sale (e.g., identification, location, etc.), loyalty data, reward data, offer data, and/or product data, etc. In some embodiments, the transaction message may also include a message type indicator indicative of an authorization request. The transaction amount may include, for example, the amount charged during the transaction and/or the discount received during the transaction.

The transaction database 206 may be configured to store a plurality of transaction messages 208 using a suitable data storage format and schema. The transaction database 206 may be a relational database that utilizes structured query language for the storage, identification, modifying, updating, accessing, etc. of structured data sets stored therein. Each transaction message 208 may be a structured data set configured to store data related to a payment transaction, and may be formatted pursuant to one or more standards, such as the ISO 8583 standard. Each transaction message 208 may include at least a first data element configured to store a geographic location and one or more additional data elements configured to store transaction data.

A querying module 218 of the processing server 102 may be configured to execute, in response to the merchant growth request command a query on the transaction database 206 to identify a subset of transaction messages where the included merchant identifier corresponds to the specific merchant identifier. Each transaction message in the identified subset may include an acceptance flag indicative of a card not present transaction. In some implementations, the acceptance flag may be indicative different occurrences, such as a card not present during the transaction, a card present during the transaction when the requested growth index is for physical growth, and/or a card not present during the transaction when the requested growth index is for e-commerce growth. The merchant growth request further includes an indication of a request for a growth index related at least one of physical growth and/or e-commerce growth. Each transaction message in the identified subset may include an acceptance flag indicative of a card present during the transaction if the requested growth index is for physical growth and/or includes an acceptance flag indicative of a card not present during the transaction if the requested growth index is for e-commerce growth.

The querying module 218 of the processing server 102 may be configured to execute queries on databases to identify information. The querying module 218 may receive one or more data values or query strings, and may execute a query string based thereon on an indicated database, such as the transaction database 206, to identify information stored therein. The querying module 218 may output the identified information to an appropriate engine or module of the processing server 102 as necessary.

An evaluation module 220 of the processing server 102 may be configured to determine a transaction volume over time for the specific merchant based on at least the transaction amount and transaction date stored in the plurality of data elements included in each transaction message in the identified subset. The time may be over a period of time which may be set automatically and/or selected by the merchant growth data requesting entity (e.g., investor, venture capital company, bank, merchant, etc.). In some implementations, the system may chart an index and/or model to display positive, negative and/or neutral trends (e.g., e-commerce, physical, social media) of a merchant.

An identification module 222 of the processing server 102 may be configured to identify social media data associated with the specific merchant, wherein the social media data may include a plurality of social data values. In some implementations, each social data value may be associated with a date and a measure of a social media presence.

The receiving device 202 of the processing server 102 may comprise a data signal superimposed with the social media data including a plurality of social media mentions. In some implementations, each social media mention may include at least a date and associated content. Identifying social media data associated with the specific merchant may comprise receiving a data signal superimposed with a plurality of social media mentions data. Social media mention data may include at least a date/time and associated content. Where a merchant is mentioned, and optionally an indication of whether the merchant is mentioned foreseeably or not. Identifying if the mention is favorable may be done manually, but given the volume of potentially thousands of mentions, may be automated by, for instance, detecting the presence of key words (e.g., “good”, “excellent”, “poor”, etc.) or ratings such as stars on Yelp® etc. In some implementations, a social media mention may be a type of user-generated content (e.g., comments, like, thumbs up, etc.). These may be converted to social data values (e.g., positive or negative, on a scale (e.g., number of stars, etc.)). The social data values may then be converted for a measurement of social media presence associated with a merchant or type of merchant. This can be a simple calculation, e.g., counting positive and/or negative mentions as a measure, but more complicated calculations may also be implemented.

The processing server 102 may identify the plurality of social data values. The associated measure of social media presence may be based on the content associated with each social media mention that includes a date corresponding to the respective associated date. The content associated with each social media mention may be related to the specific merchant or type of merchant and/or other category. In some implementations, the system may chart an index and/or model to display positive, negative and/or neutral trends (e.g., e-commerce, physical, social media) of a merchant.

The processing server 102 may be configured to identify a growth index for the specific merchant based on at least the transaction volume over time determined for the specific merchant and the measure of social media presence over time based on the associated dates.

The identification module 222 of the processing server 102 may identify the plurality of social data values, wherein the associated measure of social media presence is based on the content associated with each social media mention that includes a date corresponding to the respective associated date. The content associated with each social media mention may be related to the specific merchant or type of merchant.

The identification module 222 of the processing server 102 may be configured to identify social media data associated with the specific merchant. The social media data may include a plurality of social data values. Each social data value may be associated with a date and/or a measure of social media presence. In some implementations, social media presence may be the merchant's footprint on various social media, and web sites. For example, by creating Facebook fan page or Twitter profile, the merchant may have a presence on these sites. In some implementations, there are many websites like Pinterest®, Google+®, StumbleUpon® which merchants may create an online presence through use.

An indexing module 224 of the processing server 102 may be configured to identify a growth index for the specific merchant based on at least the transaction volume over time determined for the specific merchant and the measure of social media presence over time based on the associated dates.

In some implementations, the indexing module 224 of the processing server 102 may be configured to identify a growth index for the specific merchant based on at least the transaction volume over time determined for the specific merchant and the measure of social media presence over time based on the associated dates. In some implementations, the growth index may be an index showing the growth in a merchant's revenues, earnings, dividends and/or other figures.

Generation of the indexing model may include, for example, monitoring payment card transaction data with both e-commerce and/or brick and mortar flag for a period of time (e.g., 12-24 months). The merchant data may be aggregated by categories (e.g., merchant name, location, industry type). Social media data may be analyzed to determine a social media presence (e.g., buzz, etc.) of the merchant. An algorithm to match the business's social media presence and the corresponding e-commerce volume and/or brick and mortar volume for a period of time may be implemented.

A transmitting device 226 of the processing server 102 may be configured to electronically transmit a data signal in response to the received data signal. In some implementations, the system may chart an index and/or model to display positive, negative and/or neutral trends (e.g., e-commerce, physical, social media) of a merchant. In some implementations, the transmitted data signal is superimposed with at least the identified growth index.

The transmitting device 226 of the processing server 102 may be configured to electronically transmit a data signal in response to the received data signal, wherein the transmitted data signal is superimposed with at least the identified growth index.

The transmitting device 226 may be configured to transmit data over one or more networks via one or more network protocols. In some embodiments, the transmitting device 226 may be configured to transmit data over the payment rails, such as using specially configured infrastructure associated with payment networks 108 for the transmission of transaction messages that include sensitive financial data and information, such as identified payment credentials. In some instances, the transmitting device 226 may be configured to transmit data to merchants 104, payment networks 108, data providers 112, data requesters, and other entities via alternative networks, such as the Internet. In some embodiments, the transmitting device 226 may be comprised of multiple devices, such as different transmitting devices for transmitting data over different networks, such as a first transmitting device for transmitting data over the payment rails and a second transmitting device for transmitting data over the Internet. The transmitting device 226 may electronically transmit data signals that have data superimposed that may be parsed by a receiving computing device. In some instances, the transmitting device 226 may include one or more modules for superimposing, encoding, or otherwise formatting data into data signals suitable for transmission.

The transmitting device 226 may be configured to electronically transmit data signals to payment networks 108 and data providers 112 superimposed with requests for data. For example, the transmitting device 226 may transmit a request for transaction messages to the payment network 108, such as to request transaction messages for a geographic area and/or a period of time. The transmitting device 226 may also transmit a request for demographic characteristics, property value data, and/or social activity data to one or more data providers 112. Taking into consideration vast plurality of elements to identify high growth businesses provides more accuracy. The transmitting device 226 may also be configured to electronically transmit a data signal to a data requester or other entity in response to a request for identifying high growth businesses. The electronically transmitted data signal may be superimposed with high growth businesses identified by the indexing module 224.

A merchant database 210 of the processing server 102 may be configured to store a plurality of merchant profiles 212. Each merchant profile 212 may include a structured data set related to a merchant including at least a merchant identifier and merchant information. The querying module 218 of the processing server 102 may be further configured to execute a query on the merchant database 210 to identify a specific merchant profile 212 where the included merchant identifier corresponds to the specific merchant identifier. The transmitted data signal are further superimposed with the merchant information included in the identified specific merchant profile 212. In some implementations, the merchant information may include at least one of: name, geographic location, description, financial data, industry, and/or category code. By taking into account a plurality of data to create a model identifying high growth businesses, further accuracy is achieved.

A social media database 214 may be configured to store a plurality of social media data entries 216, wherein each social media data entry 216 includes a structured data set related to a social media mention including at least a date and associated content. The social media data associated with the specific merchant includes identifying, by the identification module 222 of the processing server 102, the plurality of social data values, wherein the associated measure of social media presence is based on the content associated with each social media mention that includes a date corresponding to the respective associated date. In some implementations, the content associated with each social media mention may be related to the specific merchant.

The processing server 102 may also include a memory 228. The memory 228 may be configured to store data for use by the processing server 102 in performing the functions discussed herein. The memory 228 may be configured to store data using suitable data formatting methods and schema and may be any suitable type of memory, such as read-only memory, random access memory, etc. The memory 228 may include, for example, encryption keys and algorithms, communication protocols and standards, data formatting standards and protocols, program code for modules and application programs of the processing server 102, and other data that may be suitable for use by the processing server 102 in the performance of the functions disclosed herein as will be apparent to persons having skill in the relevant art.

### Process for Identifying High Growth E-Commerce Businesses

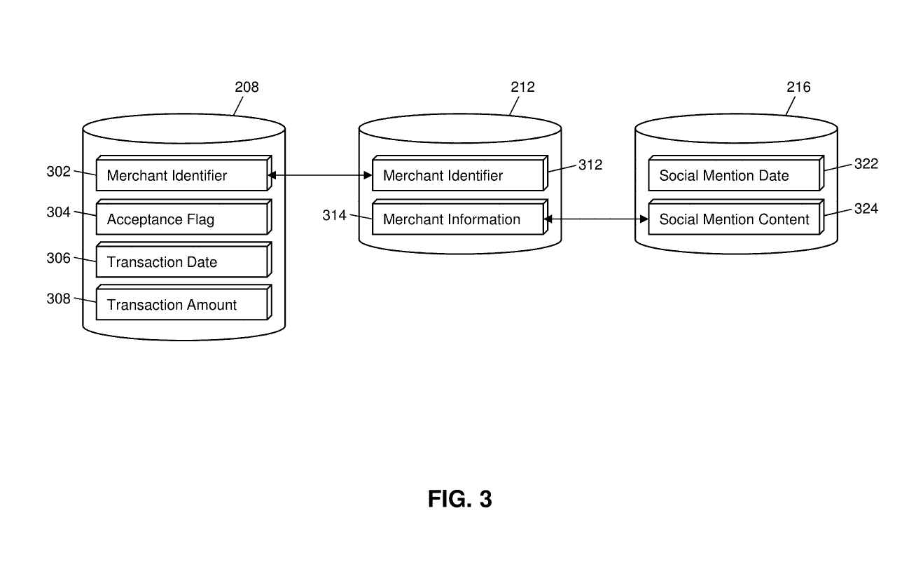

FIG. 3 is a database architecture that shows relationships among the transaction, merchant, and social media data, in accordance with exemplary embodiments.

The transaction messages 208 which are stored in the transaction database 206 may comprise several data elements. For example, some of the data elements may be a merchant identifier 302, an acceptance flag 304, a transaction date 306, and a transaction amount 308.

In some implementations, the merchant identifier 302 may be one or more of a merchant identification number, a transaction account number, a registration number, a point of sale device identifier and/or any other identifier.

In some implementations, the acceptance flag 304 may be indicative of: a card not present transaction, a card present transaction when the requested growth index is for physical growth, and/or a card not present when the requested growth index is for e-commerce growth.

The transaction messages 208 may include, for example, transaction time, transaction amount 308 transaction date 306, geographic location, primary account number, consumer data, merchant data, issuer data, acquirer data, point of sale data, loyalty data, reward data, offer data, and/or product data, etc. In some embodiments, the transaction message may also include a message type indicator indicative of an authorization request. The transaction amount 308 may include, for example, the amount charged during the transaction and/or the discount received during the transaction.

The merchant identifier 312 may also be stored in the merchant profiles 212 of the merchant database 210. The merchant profiles 212 may have corresponding merchant information 314 additionally stored in the merchant database 210.

The social media database 214 many have social media data entries 216. The social media data entries 216 may comprise a social mention information, such as a social mention date 322 and social mention content 324. The social media database and the merchant database may communicate merchant information 314 and social mention content 324 with each other.

### Identifying High Growth E-commerce Businesses Values

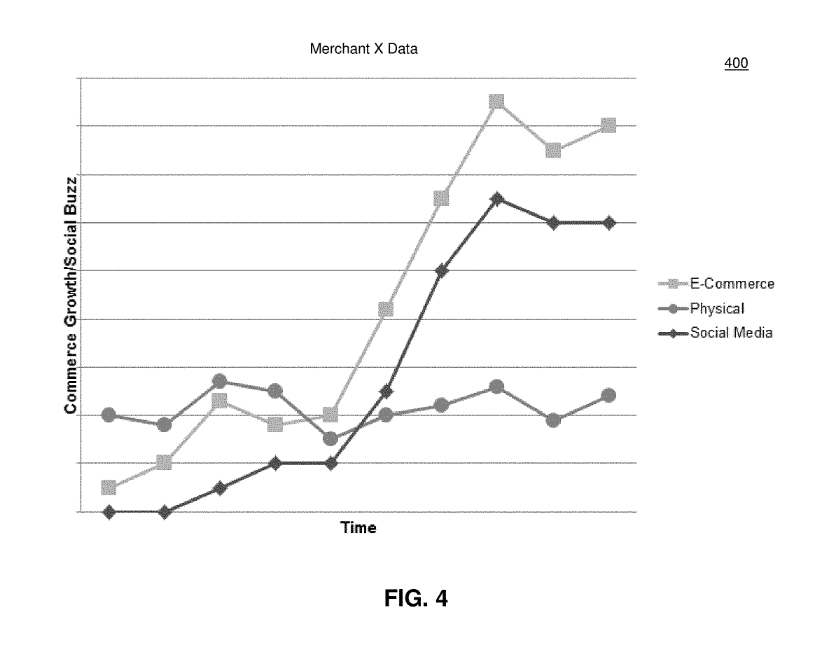

FIG. 4 is a diagram 400 illustrating a chart for measuring transaction volume and social media buzz, to provide an example of how each are used to determine growth for a merchant in accordance with exemplary embodiments.

The table 400 illustrates a particular merchant's (Merchant X) growth in e-commerce, physical growth and social media growth and/or social media buzz over a period of time.

In an exemplary embodiment, Merchant X has grown in the ecommerce space over 12 months. By monitoring Merchant X's transaction volume and social media buzz, the system has determined that their ecommerce sale has been increasing by double digits monthly and their brick sales are dropping. Moreover, positive sentiments for Merchant X's brand on social media have increased as well.

Merchant X's growth may thereby be indexed as very high (e.g., top 10%, etc.) as compared to their peers in the 50 radius. Merchant X may be looking to expand but may not know how to proceed because of a need of additional funding to expand. In some implementations, the system may map an index and/or model to display positive, negative and/or neutral trends (e.g., e-commerce, physical, social media) of Merchant X.

Based on the information generated (e.g., model, list, index, etc.) by the system, Venture Capital fund Y may obtain a list of high growth prospects as measured by the system (e.g., an index of 850 or above) and find Merchant X on the top of the growth list in the desire geographical area. Venture Capital fund Y may reach out the Merchant X with offer to help Merchant X expand with seed money

In another exemplary embodiment, Distribution/Logistic Center Z in Kansas may want to expand their business, but is having a difficult time locating the proper local prospects. Distribution/Logistic Center Z may receive a list determined by the system of high growth e-commerce merchants in the Kansas region. The list may identify Merchant X as having the highest growth potential in the Kansas area. The Distribution/Logistic Center Z may then offer Merchant X a customized offer tailored to their business for warehousing and distribution.

### Exemplary Method for Generating a Model for High Growth E-commerce Businesses

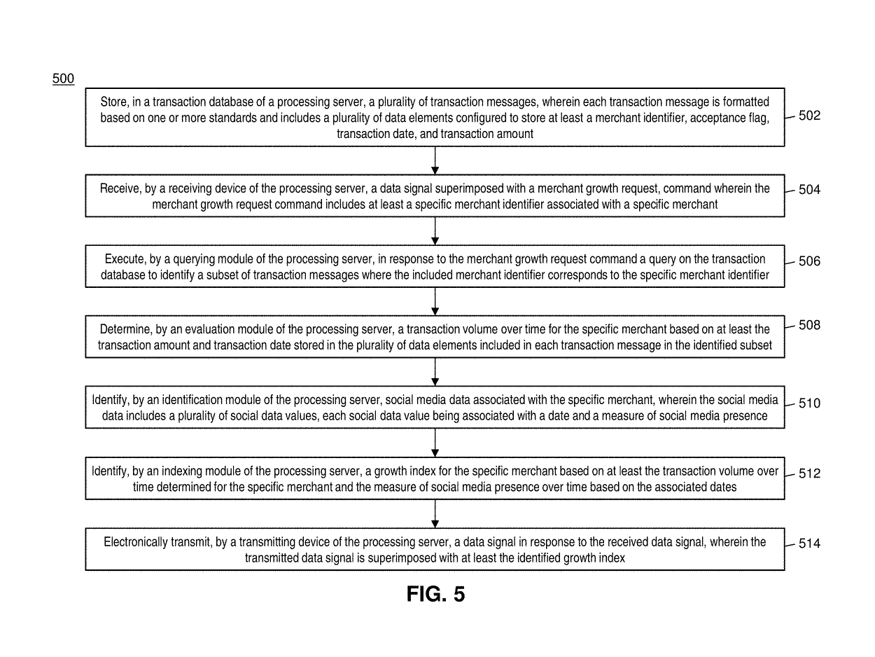

FIG. 5 is a flow chart 500 illustrating an exemplary method for generating a model for indexing neighborhood growth in accordance with exemplary embodiments.

In step 502, a plurality of transaction messages (e.g., transaction messages 208) may be stored in a transaction database (e.g., the transaction database 206) of a processing server (e.g., the processing server 102), wherein each transaction message is formatted based on one or more standards and includes a plurality of data elements configured to store at least a merchant identifier, acceptance flag, transaction date, and transaction amount. In step 504, a data signal is electronically received by a receiving device (e.g., the receiving device 202) of the processing server, wherein the data signal is superimposed with a merchant growth request command wherein the merchant growth request command includes at least a specific merchant identifier associated with a specific merchant.

In step 506, a query may be executed on the transaction database by a querying module (e.g., the querying module 218) of the processing server to identify a subset of transaction messages where the included merchant identifier corresponds to the specific merchant identifier.

In step 508, an evaluation module (e.g., the evaluation module 220) may determine a transaction volume over time for the specific merchant based on at least the transaction amount and transaction date stored in the plurality of data elements included in each transaction message in the identified subset.

In step 510, an identification module (e.g., the identification module 222) of the processing server may identify social media data associated with the specific merchant, wherein the social media data includes a plurality of social data values, each social data value being associated with a date and a measure of social media presence.

In step 512, an indexing module (e.g., the indexing module 224) of the processing server, may identify a growth index for the specific merchant based on at least the transaction volume over time determined for the specific merchant and the measure of social media presence over time based on the associated dates.

In step 514, a transmitting device (e.g., the transmitting device 226) may electronically transmit, a data signal in response to the received data signal, wherein the transmitted data signal is superimposed with at least the identified growth index.

### Payment Transaction Processing System and Process

FIG. 6 is a flow diagram 600 illustrating the processing of a payment transaction in accordance with exemplary embodiments.

The process 600 and steps included therein may be performed by one or more components of the system 100 discussed above, such as the processing server 102, merchants 104, payment network 108, etc. The processing of payment transactions using the system and process 600 illustrated in FIG. 6 and discussed below may utilize the payment rails, which may be comprised of the computing devices and infrastructure utilized to perform the steps of the process 600 as specially configured and programmed by the entities discussed below, including the transaction processing server 612, which may be associated with one or more payment networks configured to processing payment transactions. It will be apparent to persons having skill in the relevant art that the process 600 may be incorporated into the processes illustrated in FIGS. 3, 4, and 5, discussed above, with respect to the step or steps involved in the processing of a payment transaction. In addition, the entities discussed herein for performing the process 600 may include one or more computing devices or systems configured to perform the functions discussed below. For instance, the merchant 606 may be comprised of one or more point of sale devices, a local communication network, a computing server, and other devices configured to perform the functions discussed below.

In step 620, an issuing financial institution 602 may issue a payment card or other suitable payment instrument to a consumer 604. The issuing financial institution may be a financial institution, such as a bank, or other suitable type of entity that administers and manages payment accounts and/or payment instruments for use with payment accounts that can be used to fund payment transactions. The consumer 604 may have a transaction account with the issuing financial institution 602 for which the issued payment card is associated, such that, when used in a payment transaction, the payment transaction is funded by the associated transaction account. In some embodiments, the payment card may be issued to the consumer 604 physically. In other embodiments, the payment card may be a virtual payment card or otherwise provisioned to the consumer 604 in an electronic format.

In step 622, the consumer 604 may present the issued payment card to a merchant 706 for use in funding a payment transaction. The merchant 606 may be a business, another consumer, or any entity that may engage in a payment transaction with the consumer 604. The payment card may be presented by the consumer 604 via providing the physical card to the merchant 606, electronically transmitting (e.g., via near field communication, wireless transmission, or other suitable electronic transmission type and protocol) payment details for the payment card, or initiating transmission of payment details to the merchant 606 via a third party. The merchant 606 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 624, the merchant 606 may enter transaction details into a point of sale computing system. The transaction details may include the payment details provided by the consumer 604 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 606 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 606 may be an online retailer in an e-commerce transaction. In such embodiments, the transaction details may be entered in a shopping cart or other repository for storing transaction data in an electronic transaction as will be apparent to persons having skill in the relevant art.

In step 626, the merchant 606 may electronically transmit a data signal superimposed with transaction data to a gateway processor 608. The gateway processor 608 may be an entity configured to receive transaction details from a merchant 606 for formatting and transmission to an acquiring financial institution 610. In some instances, a gateway processor 608 may be associated with a plurality of merchants 606 and a plurality of acquiring financial institutions 610. In such instances, the gateway processor 608 may receive transaction details for a plurality of different transactions involving various merchants, which may be forwarded on to appropriate acquiring financial institutions 610. By having relationships with multiple acquiring financial institutions 610 and having the requisite infrastructure to communicate with financial institutions using the payment rails, such as using application programming interfaces associated with the gateway processor 608 or financial institutions used for the submission, receipt, and retrieval of data, a gateway processor 608 may act as an intermediary for a merchant 606 to be able to conduct payment transactions via a single communication channel and format with the gateway processor 608, without having to maintain relationships with multiple acquiring financial institutions 610 and payment processors and the hardware associated thereto. Acquiring financial institutions 610 may be financial institutions, such as banks, or other entities that administers and manages payment accounts and/or payment instruments for use with payment accounts. In some instances, acquiring financial institutions 610 may manage transaction accounts for merchants 606. In some cases, a single financial institution may operate as both an issuing financial institution 602 and an acquiring financial institution 610.

The data signal transmitted from the merchant 606 to the gateway processor 608 may be superimposed with the transaction details for the payment transaction, which may be formatted based on one or more standards. In some embodiments, the standards may be set forth by the gateway processor 608, which may use a unique, proprietary format for the transmission of transaction data to/from the gateway processor 608. In other embodiments, a public standard may be used, such as the International Organization for Standardization's ISO 8783 standard. The standard may indicate the types of data that may be included, the formatting of the data, how the data is to be stored and transmitted, and other criteria for the transmission of the transaction data to the gateway processor 608.

In step 628, the gateway processor 608 may parse the transaction data signal to obtain the transaction data superimposed thereon and may format the transaction data as necessary. The formatting of the transaction data may be performed by the gateway processor 608 based on the proprietary standards of the gateway processor 608 or an acquiring financial institution 610 associated with the payment transaction. The proprietary standards may specify the type of data included in the transaction data and the format for storage and transmission of the data. The acquiring financial institution 610 may be identified by the gateway processor 608 using the transaction data, such as by parsing the transaction data (e.g., deconstructing into data elements) to obtain an account identifier included therein associated with the acquiring financial institution 610. In some instances, the gateway processor 608 may then format the transaction data based on the identified acquiring financial institution 610, such as to comply with standards of formatting specified by the acquiring financial institution 610. In some embodiments, the identified acquiring financial institution 610 may be associated with the merchant 606 involved in the payment transaction, and, in some cases, may manage a transaction account associated with the merchant 606.

In step 630, the gateway processor 608 may electronically transmit a data signal superimposed with the formatted transaction data to the identified acquiring financial institution 610. The acquiring financial institution 610 may receive the data signal and parse the signal to obtain the formatted transaction data superimposed thereon. In step 632, the acquiring financial institution may generate an authorization request for the payment transaction based on the formatted transaction data. The authorization request may be a specially formatted transaction message that is formatted pursuant to one or more standards, such as the ISO 8783 standard and standards set forth by a payment processor used to process the payment transaction, such as a payment network. The authorization request may be a transaction message that includes a message type indicator indicative of an authorization request, which may indicate that the merchant 606 involved in the payment transaction is requesting payment or a promise of payment from the issuing financial institution 602 for the transaction. The authorization request may include a plurality of data elements, each data element being configured to store data as set forth in the associated standards, such as for storing an account number, application cryptogram, transaction amount, issuing financial institution 602 information, etc.

In step 634, the acquiring financial institution 610 may electronically transmit the authorization request to a transaction processing server 612 for processing. The transaction processing server 612 may be comprised of one or more computing devices as part of a payment network configured to process payment transactions. In some embodiments, the authorization request may be transmitted by a transaction processor at the acquiring financial institution 610 or other entity associated with the acquiring financial institution. The transaction processor may be one or more computing devices that include a plurality of communication channels for communication with the transaction processing server 612 for the transmission of transaction messages and other data to and from the transaction processing server 612. In some embodiments, the payment network associated with the transaction processing server 612 may own or operate each transaction processor such that the payment network may maintain control over the communication of transaction messages to and from the transaction processing server 612 for network and informational security.

In step 636, the transaction processing server 612 may perform value-added services for the payment transaction. Value-added services may be services specified by the issuing financial institution 602 that may provide additional value to the issuing financial institution 602 or the consumer 604 in the processing of payment transactions. Value-added services may include, for example, fraud scoring, transaction or account controls, account number mapping, offer redemption, loyalty processing, etc. For instance, when the transaction processing server 612 receives the transaction, a fraud score for the transaction may be calculated based on the data included therein and one or more fraud scoring algorithms and/or engines. In some instances, the transaction processing server 612 may first identify the issuing financial institution 602 associated with the transaction, and then identify any services indicated by the issuing financial institution 602 to be performed. The issuing financial institution 602 may be identified, for example, by data included in a specific data element included in the authorization request, such as an issuer identification number. In another example, the issuing financial institution 602 may be identified by the primary account number stored in the authorization request, such as by using a portion of the primary account number (e.g., a bank identification number) for identification.

In step 638, the transaction processing server 612 may electronically transmit the authorization request to the issuing financial institution 602. In some instances, the authorization request may be modified, or additional data included in or transmitted accompanying the authorization request as a result of the performance of value-added services by the transaction processing server 612. In some embodiments, the authorization request may be transmitted to a transaction processor (e.g., owned or operated by the transaction processing server 612) situated at the issuing financial institution 602 or an entity associated thereof, which may forward the authorization request to the issuing financial institution 602.

In step 640, the issuing financial institution 602 may authorize the transaction account for payment of the payment transaction. The authorization may be based on an available credit amount for the transaction account and the transaction amount for the payment transaction, fraud scores provided by the transaction processing server 612, and other considerations that will be apparent to persons having skill in the relevant art. The issuing financial institution 602 may modify the authorization request to include a response code indicating approval (e.g., or denial if the transaction is to be denied) of the payment transaction. The issuing financial institution 602 may also modify a message type indicator for the transaction message to indicate that the transaction message is changed to be an authorization response. In step 642, the issuing financial institution 602 may transmit (e.g., via a transaction processor) the authorization response to the transaction processing server 612.

In step 644, the transaction processing server 612 may forward the authorization response to the acquiring financial institution 610 (e.g., via a transaction processor). In step 646, the acquiring financial institution may generate a response message indicating approval or denial of the payment transaction as indicated in the response code of the authorization response, and may transmit the response message to the gateway processor 608 using the standards and protocols set forth by the gateway processor 608. In step 648, the gateway processor 608 may forward the response message to the merchant 606 using the appropriate standards and protocols. In step 650, assuming the transaction was approved, the merchant 606 may then provide the products purchased by the consumer 604 as part of the payment transaction to the consumer 604.

In some embodiments, once the process 600 has completed, payment from the issuing financial institution 602 to the acquiring financial institution 610 may be performed. In some instances, the payment may be made immediately or within one business day. In other instances, the payment may be made after a period of time, and in response to the submission of a clearing request from the acquiring financial institution 610 to the issuing financial institution 602 via the transaction processing server 602. In such instances, clearing requests for multiple payment transactions may be aggregated into a single clearing request, which may be used by the transaction processing server 612 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 640), the transaction processing server 612 may be configured to perform authorization of transactions on behalf of the issuing financial institution 602. Such actions may be referred to as “stand-in processing,” where the transaction processing server “stands in” as the issuing financial institution 602. In such instances, the transaction processing server 612 may utilize rules set forth by the issuing financial institution 602 to determine approval or denial of the payment transaction, and may modify the transaction message accordingly prior to forwarding to the acquiring financial institution 610 in step 644. The transaction processing server 612 may retain data associated with transactions for which the transaction processing server 612 stands in, and may transmit the retained data to the issuing financial institution 602 once communication is reestablished. The issuing financial institution 602 may then process transaction accounts accordingly to accommodate for the time of lost communication.

In another example, if the transaction processing server 612 is unavailable for submission of the authorization request by the acquiring financial institution 610, then the transaction processor at the acquiring financial institution 610 may be configured to perform the processing of the transaction processing server 612 and the issuing financial institution 602. The transaction processor may include rules and data suitable for use in making a determination of approval or denial of the payment transaction based on the data included therein. For instance, the issuing financial institution 602 and/or transaction processing server 612 may set limits on transaction type, transaction amount, etc. that may be stored in the transaction processor and used to determine approval or denial of a payment transaction based thereon. In such instances, the acquiring financial institution 610 may receive an authorization response for the payment transaction even if the transaction processing server 612 is unavailable, ensuring that transactions are processed and no downtime is experienced even in instances where communication is unavailable. In such cases, the transaction processor may store transaction details for the payment transactions, which may be transmitted to the transaction processing server 612 (e.g., and from there to the associated issuing financial institutions 602) once communication is reestablished.

In some embodiments, transaction processors may be configured to include a plurality of different communication channels, which may utilize multiple communication cards and/or devices, to communicate with the transaction processing server 612 for the sending and receiving of transaction messages. For example, a transaction processor may be comprised of multiple computing devices, each having multiple communication ports that are connected to the transaction processing server 612. In such embodiments, the transaction processor may cycle through the communication channels when transmitting transaction messages to the transaction processing server 612, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 610 may identify that an authorization request involves an issuing financial institution 602 (e.g., via the bank identification number included in the transaction message) for which no value-added services are required. The transaction processor at the acquiring financial institution 610 may then transmit the authorization request directly to the transaction processor at the issuing financial institution 602 (e.g., without the authorization request passing through the transaction processing server 612), where the issuing financial institution 602 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 612 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 608, acquiring financial institution 610, etc.) for processing using this advanced network, and to quickly and efficiently receive a response regarding the ability for a consumer 604 to fund the payment transaction.

### Computer System Architecture

FIG. 7 is a block diagram 700 illustrating a computer system architecture in accordance with exemplary embodiments. For example, the processing server 102 of

FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device specifically configured to perform the functions discussed herein. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

The processor device 704 may comprise one or more modules or engines configured to perform the functions of the computer system 700. Each of the modules or engines may be implemented using hardware and, in some instances, may also utilize software, such as corresponding to program code and/or programs stored in the main memory 708 or secondary memory 710. In such instances, program code may be compiled by the processor device 704 (e.g., by a compiling module or engine) prior to execution by the hardware of the computer system 700. For example, the program code may be source code written in a programming language that is translated into a lower level language, such as assembly language or machine code, for execution by the processor device 704 and/or any additional hardware components of the computer system 700. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for generating and using indexing models for neighborhood growth. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identifying a high growth business from combined data sets, comprising:
storing, in a transaction database of a processing server, a plurality of transaction messages, wherein each transaction message is formatted based on one or more standards and includes data related to a payment transaction including a plurality of data elements configured to store at least a merchant identifier, acceptance flag, transaction date, and transaction amount;
receiving, by a receiving device of the processing server, a data signal superimposed with a merchant growth request command, wherein the merchant growth request command includes at least a specific merchant identifier associated with a specific merchant;
executing, by a querying module of the processing server, in response to the merchant growth request command a query on the transaction database to identify a subset of transaction messages where the included merchant identifier corresponds to the specific merchant identifier;
determining, by an evaluation module of the processing server, a transaction volume over time for the specific merchant based on at least the transaction amount and transaction date stored in the plurality of data elements included in each transaction message in the identified subset;
identifying, by an identification module of the processing server, social media data associated with the specific merchant, wherein the social media data includes a plurality of social data values, each social data value being associated with a date and a measure of social media presence;
identifying, by an indexing module of the processing server, a growth index for the specific merchant based on at least the transaction volume over time determined for the specific merchant and the measure of social media presence over time based on the associated dates; and
electronically transmitting, by a transmitting device of the processing server, a data signal in response to the received data signal, wherein the transmitted data signal is superimposed with at least the identified growth index.

2. The method of claim 1, wherein each transaction message in the identified subset includes an acceptance flag indicative of a card not present transaction.

3. The method of claim 1, wherein
the merchant growth request further includes an indication of a request for a growth index related to one of: physical growth and e-commerce growth, and
each transaction message in the identified subset includes an acceptance flag indicative of a card present transaction if the requested growth index is for physical growth or includes an acceptance flag indicative of a card not present transaction if the requested growth index is for e-commerce growth.

4. The method of claim 1, wherein identifying social media data associated with the specific merchant comprises:
receiving, by the receiving device of the processing server, a data signal superimposed with the social media data.

5. The method of claim 1, wherein identifying social media data associated with the specific merchant comprises:
receiving, by the receiving device of the processing server, a data signal superimposed with a plurality of social media mentions data, wherein each social media mention data includes at least a date and associated content; and
identifying, by the identification module of the processing server, the plurality of social data values, wherein the associated measure of social media presence is based on the content associated with each social media mention that includes a date corresponding to the respective associated date.

6. The method of claim 5, wherein the content associated with each social media mention is related to the specific merchant.

7. The method of claim 1, further comprising:
storing, in a social media database, a plurality of social media data entries, wherein each social media data entry includes a structured data set related to a social media mention including at least a date and associated content, wherein
identifying social media data associated with the specific merchant includes identifying, by the identification module of the processing server, the plurality of social data values, wherein the associated measure of social media presence is based on the content associated with each social media mention that includes a date corresponding to the respective associated date.

8. The method of claim 7, wherein the content associated with each social media mention is related to the specific merchant.

9. The method of claim 1, further comprising:
storing, in a merchant database of the processing server, a plurality of merchant profiles, wherein each merchant profile includes a structured data set related to a merchant including at least a merchant identifier and merchant information; and
executing, by the querying module of the processing server, a query on the merchant database to identify a specific merchant profile where the included merchant identifier corresponds to the specific merchant identifier, wherein
the transmitted data signal is further superimposed with the merchant information included in the identified specific merchant profile.

10. The method of claim 9, wherein the merchant information includes at least one of: name, geographic location, description, financial data, industry, and category code.

11. A system for identifying a high growth business from combined data sets, comprising:
a transaction database of a processing server configured to store a plurality of transaction messages, wherein each transaction message is formatted based on one or more standards and includes data related to a payment transaction including a plurality of data elements configured to store at least a merchant identifier, acceptance flag, transaction date, and transaction amount;
a receiving device of the processing server configured to receive a data signal superimposed with a merchant growth request command, wherein the merchant growth request command includes at least a specific merchant identifier associated with a specific merchant;
a querying module of the processing server configured to execute, in response to the merchant growth request command a query on the transaction database to identify a subset of transaction messages where the included merchant identifier corresponds to the specific merchant identifier;
an evaluation module of the processing server configured to determine a transaction volume over time for the specific merchant based on at least the transaction amount and transaction date stored in the plurality of data elements included in each transaction message in the identified subset;
an identification module of the processing server configured to identify social media data associated with the specific merchant, wherein the social media data includes a plurality of social data values, each social data value being associated with a date and a measure of social media presence;
an indexing module of the processing server configured to identify a growth index for the specific merchant based on at least the transaction volume over time determined for the specific merchant and the measure of social media presence over time based on the associated dates; and
a transmitting device of the processing server configured to electronically transmit a data signal in response to the received data signal, wherein the transmitted data signal is superimposed with at least the identified growth index.

12. The system of claim 11, wherein each transaction message in the identified subset includes an acceptance flag indicative of a card not present transaction.

13. The system of claim 11, wherein
the merchant growth request further includes an indication of a request for a growth index related to one of: physical growth and e-commerce growth, and
each transaction message in the identified subset includes an acceptance flag indicative of a card present transaction if the requested growth index is for physical growth or includes an acceptance flag indicative of a card not present transaction if the requested growth index is for e-commerce growth.

14. The system of claim 11, wherein identifying social media data associated with the specific merchant comprises:
receiving, by the receiving device of the processing server, a data signal superimposed with the social media data.

15. The system of claim 11, wherein identifying social media data associated with the specific merchant comprises:
receiving, by the receiving device of the processing server, a data signal superimposed with a plurality of social media mentions, wherein each social media mention includes at least a date and associated content; and
identifying, by the identification module of the processing server, the plurality of social data values, wherein the associated measure of social media presence is based on the content associated with each social media mention that includes a date corresponding to the respective associated date.

16. The system of claim 15, wherein the content associated with each social media mention is related to the specific merchant.

17. The system of claim 11, further comprising:
a social media database configured to store a plurality of social media data entries, wherein each social media data entry includes a structured data set related to a social media mention including at least a date and associated content, wherein
identifying social media data associated with the specific merchant includes identifying, by the identification module of the processing server, the plurality of social data values, wherein the associated measure of social media presence is based on the content associated with each social media mention that includes a date corresponding to the respective associated date.

18. The system of claim 17, wherein the content associated with each social media mention is related to the specific merchant.

19. The system of claim 11, further comprising:
a merchant database of the processing server configured to store a plurality of merchant profiles, wherein each merchant profile includes a structured data set related to a merchant including at least a merchant identifier and merchant information, wherein
the querying module of the processing server is further configured to execute a query on the merchant database to identify a specific merchant profile where the included merchant identifier corresponds to the specific merchant identifier, and
the transmitted data signal is further superimposed with the merchant information included in the identified specific merchant profile.

20. The system of claim 19, wherein the merchant information includes at least one of: name, geographic location, description, financial data, industry, and category code.
